(19) United States
(12) Patent Application Publication
(10) Pub. No.: US 2008/0025780 A1
(43) Pub. Date: Jan. 31, 2008

(54) INFLATABLE KEYBOARD

(75) Inventors: SHIH-FANG WONG, Tu-Cheng (TW); DE-ZHI LI, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 11/778,072

(22) Filed: Jul. 16, 2007

(30) Foreign Application Priority Data
Jul. 26, 2006 (CN) 200610061802.9

(51) Int. Cl. G06F 3/02

(52) U.S. Cl. 400/472

(57) ABSTRACT

An exemplary inflatable keyboard includes an inflatable bag, a flexible printed circuit board (FPCB), an inflating unit electrically connected with the FPCB, an inflating button and a USB interface connects to a host device. The inflatable bag includes a faceplate portion and at least one key. An inlet valve and an outlet valve mounted on the inflatable bag. The FPCB receives a startup signal and a shutdown signal via the USB interface, used as an inflate signal and a deflate signal respectively. The inflating button produce an inflate signal and a deflate signal respectively when the inflating button is actuated by a user. The inflating unit includes a pressure gauge, an air pump, and a valve control device. The inflating unit configured for inflating the inflatable bag to the inflated state upon receiving an inflate signal, and allowing deflation of the inflatable bag upon receiving a deflate signal.

### BACKGROUND OF THE INVENTION

1. Field of the Invention

The present invention relates to keyboards, and more specifically to an inflatable keyboard.

2. Description of Related Art

With the development of host device technology and personal computers, a personal host device is used in a wide range of applications. For example, various types of personal computers (PCs) and computing devices have become a very popular part of the home and office. A typical keyboard of a personal host device (e.g. a PC) includes a housing, a pair of supporting legs, keyboard circuits, and a plurality of keys. Most keyboards have numerous keys which are sized for allowing entry of commands or data quickly and easily. However, a volume of the keyboard is quite large, and this can make it inconvenient to store or transport the keyboard.

Therefore it is desired to provide a keyboard which is small and compact for convenient storage and transport.

### SUMMARY OF INVENTION

An inflatable keyboard in accordance with a preferred embodiment includes: at least one key; a Universal Serial Bus (USB) interface configured for connecting the inflatable keyboard to a host device; an inflatable bag made of polymeric material such as, vinyl, polypropylene or rubber and the like; a flexible printed circuit board (FPCB); and an inflating unit. The inflatable bag includes faceplate portion and a plurality of keys. An inlet valve and an outlet valve mounted on the inflatable bag. The inflatable bag acquires a predetermined size and shape when fully inflated. The FPCB is contained in the inflatable bag, and configured for producing at least one key signal and transmitting the at least one key signal to the host device via the USB interface when the at least one key is actuated by a user. The FPCB receives a startup signal and a shutdown signal of the host device, the startup signal is used as an inflate signal, the shutdown signal is used as a deflate signal. The inflating unit connects with the FPCB, the inflating unit includes: air pump for inflating the inflatable bag, a valve control device for opening the inlet valve according to a inflate signal and closing an outlet valve, and opening the outlet valve according to a deflate signal, a pressure gauge for measuring a pressure inside of the inflatable bag. The inflating unit configured for inflating the inflatable bag to the inflated state upon receiving an inflate signal, and allowing deflation of the inflatable bag upon receiving a deflate signal.

An inflating button is mounted on the faceplate portion of the inflatable bag for producing an inflate signal and a deflate signal. The inflating button is electrically connected with the FPCB. The FPCB outputs a control signal accordance with a measured pressure measured by the pressure gauge, the control signal is used to control the inflating unit. When the keyboard is fully inflated, the keyboard is said to be in an inflated state, and has substantially the same shape and size as a conventional keyboard. In the inflated state, the keyboard is enabled and can perform all its functions normally. When the keyboard is fully deflated, the keyboard is said to be in a deflated state, and may be folded or rolled up. In the deflated state, the keyboard is disabled and cannot function.

An advantage of the inflatable keyboard is that it is small and compact, and therefore conveniently stored and transported. Nevertheless, when in use, the inflatable keyboard provides entry of commands or data quickly and easily.

Other features and advantages will be apparent to one with skill in the art upon examination of the following drawings and detailed description. In the drawings, all the views are schematic.

### BRIEF DESCRIPTION OF DRAWINGS

FIG. 1 is an isometric view of an inflatable keyboard according to a first preferred embodiment of the present invention, showing the inflatable keyboard in a deflated state, and partially rolled up.

FIG. 2 is similar to FIG. 1, but showing the inflatable keyboard in a flat state, and partly cut away.

FIG. 3 is a block diagram of the inflatable keyboard of the first preferred embodiment.

FIG. 4 is an isometric view of an inflatable keyboard in accordance with a second preferred embodiment of the present invention, showing the inflatable keyboard in a flat state, and partly cut away.

FIG. 5 is a block diagram of the inflatable keyboard of the second preferred embodiment.

### DETAILED DESCRIPTION OF THE EMBODIMENTS

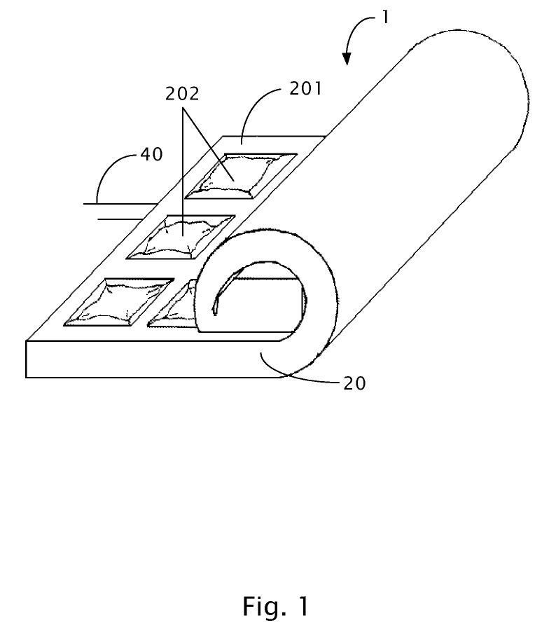

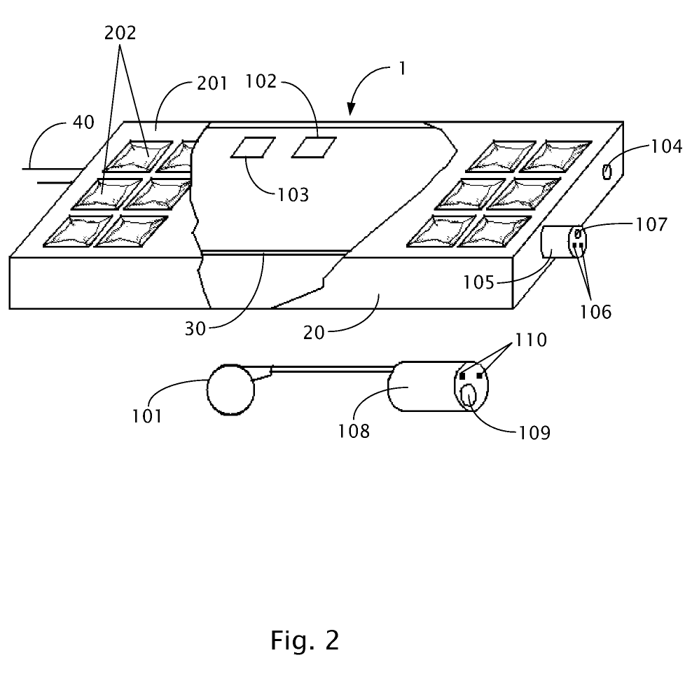

Referring to FIG. 1, this is an isometric view of an inflatable keyboard according to a first preferred embodiment of the present invention, showing the inflatable keyboard in a deflated state and partially rolled up. The inflatable keyboard 1 includes an inflatable bag 20 made of flexible polymeric material such as vinyl, polypropylene, rubber, or the like. Referring also to FIG. 2, the inflatable bag 20 includes a faceplate portion 201 and at least one key 202. In the illustrated embodiment, there is a plurality of keys 202. An outlet valve 104 and an inlet valve 105 are mounted on the inflatable bag 20. The outlet valve 104 is used for deflating the inflatable bag 20 according to a deflate signal. The inlet valve 105 includes an inflating lumen 107 and two electrically conductive contact points 106. A connector 108 is used for connecting an air pump 101 to the inflatable keyboard 1 to inflate the inflatable keyboard 1. The connector 108 includes an inflating lumen 109 and two electrically conductive contact points 110, which are used to couple with the inflating lumen 107 and the conductive contact points 106 of the inlet valve 105 respectively. The conductive contact points 106 and the conductive contact points 110 cooperatively transmit power and control signals from the inflatable keyboard 1 to the air pump 101. A flexible printed board (FPCB) 30 is fixed inside the inflatable bag 20 by heat sealing or another suitable known method. A valve control device 102 and a pressure gauge 103 are both connected with the FPCB 30, and obtain electrical power from a host device (not shown) via a Universal Serial Bus (USB) interface 40. The USB interface 40 also provides a communication path between the host device and the FPCB 30. For example, the USB interface 40 enables transmitting of a plurality of control signals from the host device to the FPCB 30, and transmitting of key signals from the FPCB 30 to the host device.

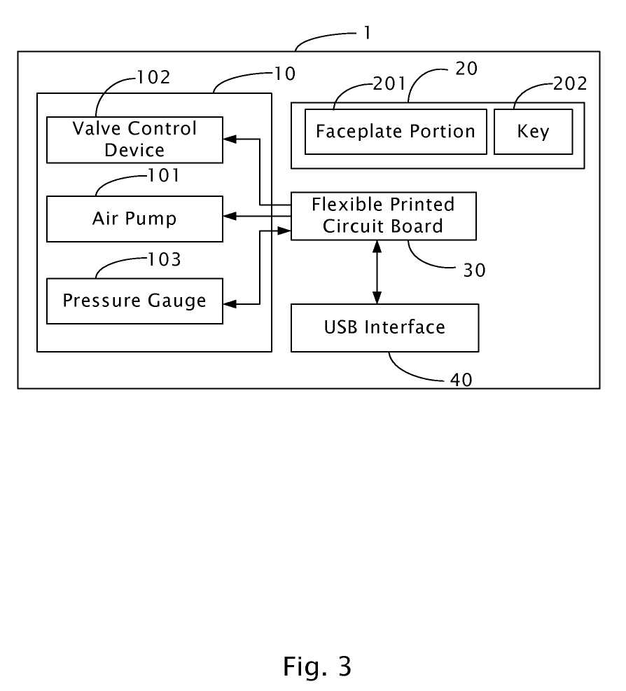

Referring also to FIG. 3, the keyboard 1 further includes an inflating unit 10. The inflating unit 10 includes the air pump 101, the valve control device 102, and the pressure gauge 103. The inflating unit 10 inflates or deflates the keyboard 1 in accordance with signals transmitted by the FPCB 30. When the inflatable keyboard 1 is fully inflated, the inflatable keyboard 1 is in an inflated state. In the inflated state, the inflatable keyboard 1 has substantially a same shape and size as a conventional keyboard. The inflatable keyboard 1 is thus enabled and can perform all its functions normally. When the inflatable keyboard 1 is fully deflated, the inflatable keyboard 1 is in a deflated state. In the deflated state, the inflatable keyboard 1 can be folded or rolled up, which makes it inconvenient to store or transport.

The FPCB 30 receives a startup signal from the host device via the USB interface 40 during a startup of the host device. The startup signal is read as an inflate signal for the inflatable keyboard 1. The inflate signal triggers the air pump 101, the valve control device 102, and the pressure gauge 103. The valve control device 102 opens the inlet valve 105 to allow air into the inflatable bag 20 via the inflating lumen 107, and simultaneously closes the outlet valve 104. The air pump 101 inflates the inflatable bag 20. The pressure gauge 103 detects and measures a pressure inside the inflatable bag 20, and sends a measured pressure in real time to the FPCB 30. If and when the measured pressure reaches a predetermined threshold value stored in the FPCB 30, the FPCB 30 outputs a control signal to both the air pump 101 and the valve control device 102. Upon receiving the control signal, the air pump 101 stops inflating the inflatable keyboard 1, and the valve control device 102 closes the inlet valve 105. The keyboard 1 is thus in the inflated state.

The FPCB 30 receives a shutdown signal from the host device via the USB interface 40 during a shutdown of the host device. The shutdown signal is read as a deflate signal for the inflatable keyboard 1. The deflate signal triggers the valve control device 102 to open the outlet valve 104 to allow deflation of the inflatable bag 20. The inflatable keyboard 1 can thus be brought to the deflated state by a user.

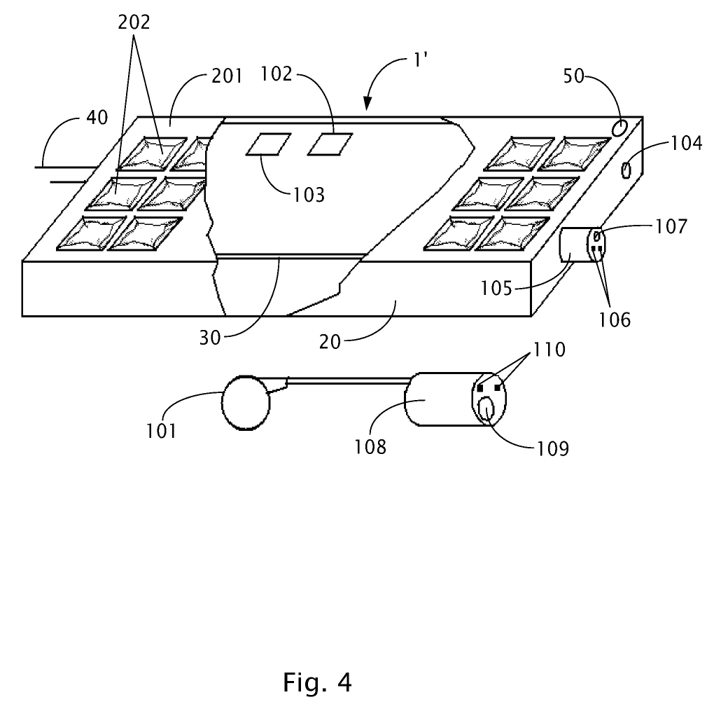

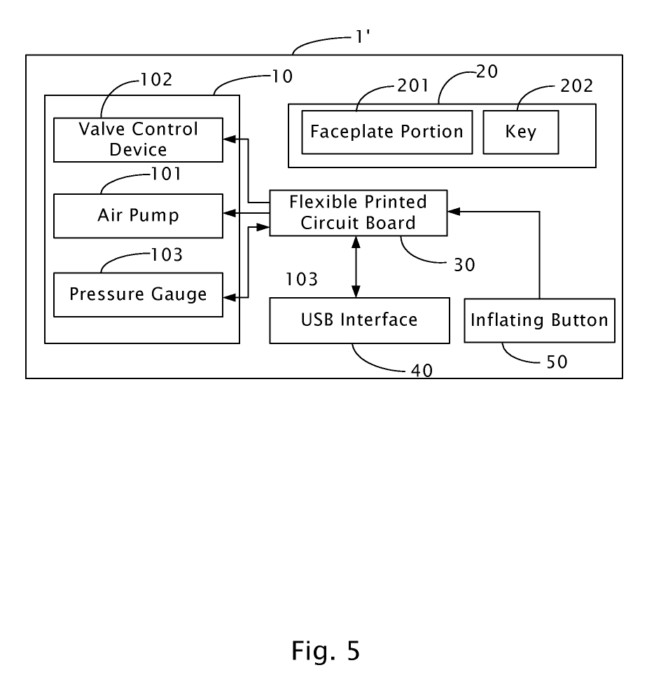

Referring to FIGS. 4 and 5, this is an isometric view of an inflatable keyboard 1′ in accordance with a second preferred embodiment of the present invention, showing the inflatable keyboard in a flat state and partly cut away. Compared with the inflatable keyboard 1, the inflatable keyboard 1′ further includes an inflating button 50 connected with the FPCB 30. The inflating button 50 is mounted on the faceplate portion 201. In an alternative embodiment, the inflating button 50 can instead be one of the keys 202. Referring also to FIG. 5, when the inflating button 50 is pressed, the FPCB 30 produces an inflate signal, and outputs the inflate signal to the air pump 101, the valve control device 102, and the pressure gauge 103. Upon receiving the inflate signal, the valve control device 102 opens the inlet valve 105 and closes the outlet valve 104, the air pump 101 inflates the inflatable bag 20, and the pressure gauge 103 begins to detect and measure a pressure inside the inflatable bag 20. The pressure gauge 103 sends the measured pressure to the FPCB 30. When the measured pressure reaches the predetermined threshold value stored in the FPCB 30, the FPCB 30 outputs a control signal to both the air pump 101 and the valve control device 102. The air pump 101 stops inflating the inflatable bag 20, and the valve control device 102 closes the inlet valve 105. The keyboard 1′ is thus in the inflated state.

When the inflating button 50 is re-pressed, the FPCB 30 produces a deflate signal, and outputs the deflate signal to the valve control device 102. The valve control device 102 opens the outlet valve 104 to allow deflation of the inflatable bag 20. The keyboard 1′ can thus be brought to the deflated state by the user.

Although the present invention has been specifically described on the basis of preferred and exemplary embodiments, the invention is not to be construed as being limited thereto. Various changes and modifications may be made to the embodiments without departing from the scope and spirit of the invention.

What is claimed is:

1. An inflatable keyboard comprising:
at least one key;
a Universal Serial Bus (USB) interface configured for connecting the inflatable keyboard to a host device;
an inflatable bag configured to acquire a predetermined size and shape when inflated;
a flexible printed circuit board (FPCB) contained in the inflatable bag, and configured for producing at least one key signal and transmitting the at least one key signal to the host device via the USB interface when the inflatable bag is in an inflated state and the at least one key is actuated by a user; and
an inflating unit configured for inflating the inflatable bag to the inflated state upon receiving an inflate signal, and allowing deflation of the inflatable bag upon receiving a deflate signal.

2. The inflatable keyboard as claimed in claim 1, wherein the inflate signal is comprised in a startup signal of the host device, and the deflate signal is comprised in a shutdown signal of the host device.

3. The inflatable keyboard as claimed in claim 1, further comprising an inflating button, wherein the FPCB is configured for producing the inflate signal when the inflating button is actuated by a user, and producing the deflate signal when the inflating button is actuated by a user.

4. The inflatable keyboard as claimed in claim 3, wherein the at least one key is a plurality of keys, and the inflating button is one of the plurality of keys.

5. The inflatable keyboard as claimed in claim 1, wherein the inflating unit comprises an air pump, and the air pump is configured to inflate the inflatable bag in accordance with the inflate signal.

6. The inflatable keyboard as claimed in claim 5, further comprising an inlet valve and an outlet value both mounted on the inflatable bag, wherein the inflating unit further comprises a valve control device, and the valve control device is configured for opening the inlet valve to allow inflation of the inflatable bag according to the inflate signal, and for opening the outlet valve to allow deflation of the inflatable bag according to the deflate signal.

7. The inflatable keyboard as claimed in claim 6, wherein the inlet valve comprises an inflating lumen and two electrically conductive contact points.

8. The inflatable keyboard as claimed in claim 7, wherein the air pump further comprises a connector, the connector comprises an inflating lumen and two electrically conductive contact points, and the inflating lumen and electrically conductive contact points of the connector and the inflating lumen and electrically conductive contact points of the inlet valve are configured to be detachably connected with each other, respectively.

9. The inflatable keyboard as claimed in claim 6, wherein the inflating unit further comprises a pressure gauge configured for measuring a pressure inside the inflatable bag and outputting the measured pressure to the FPCB, wherein when the measured pressure reaches a predetermined threshold value, the FPCB outputs a control signal to the air pump and the valve control device, and the air pump accordingly stops inflating the inflatable bag, and the valve control device accordingly closes the inlet valve.
